(19) United States
(12) Patent Application Publication
(10) Pub. No.: US 2004/0112001 A1
(43) Pub. Date: Jun. 17, 2004

(54) Anchor sleeve for injection fixing

(76) Inventors: Amir Assadi, Emmendingen (DE); Steffen Schneider, Freudenstadt (DE); Gebhard Griesbaum, Emmendingen (DE); Rainer Heizmann, Emmendingen (DE); Clemens Schmidt, Denzingen (DE)

Correspondence Address: Striker Striker & Stenby, 103 East Neck Road, Huntington, NY, 11743, US

(21) Appl. No.: 10/472,633

(22) PCT Filed: Jan. 16, 2002
(86) PCT No.: PCT/EP02/00355

(30) Foreign Application Priority Data
Mar. 22, 2001 (DE) 201 05 013.7

(51) Int. Cl. E04B 1/38; E04C 5/00

(52) U.S. Cl. 52/698

(57) ABSTRACT

The invention relates to an anchor sleeve (mesh sleeve 10) for injection fixing of an anchor rod, not illustrated, in a hole, not illustrated, drilled in masonry. The invention provides for the anchor sleeve (10) to be provided with inwardly extending supporting ribs (18) for the anchor rod and for the supporting ribs (18) to be arranged anchor sleeve chords instead of radially. The supporting ribs (18) hold an anchor rod coaxially in the anchor sleeve (10) and permit accommodation to different diameters as a consequence of deformation. By the arrangement of the supporting ribs (18) as chords, the supporting ribs (18) can be pressed more easily to one side and permit accommodation to a large range of diameters.

The invention relates to an anchor sleeve for injection fixing having the features of the preamble to claim 1. Injection fixing in this context means anchoring an anchor rod with, for example, mortar, in a hole drilled in masonry.

Such anchor sleeves are known per se. They are in the form of mesh sleeves, for example, of plastics material, and for anchoring are introduced into a hole drilled in masonry. Mortar is subsequently injected into the anchor sleeve and passes out of the anchor sleeve through mesh holes of the anchor sleeve in the form of a mesh sleeve. The mesh holes form outlet openings for the mortar injected into the anchor sleeve. The anchor rod is subsequently introduced into the anchor sleeve. It displaces and compacts the mortar and, once the mortar has hardened, is anchored in the bore in the masonry.

The known anchor sleeves have the drawback that they are designed only for a specific diameter of anchor rod.

The invention is based on the problem of constructing an anchor sleeve of the kind mentioned above so that it is suitable for different diameters of anchor rod.

That problem is solved in accordance with the invention by the features of claim 1. The anchor sleeve according to the invention having the features of claim 1 has inwardly protruding supporting elements which, in the anchor sleeve, support an anchor rod introduced between them into the anchor sleeve. The supporting elements can be studs, projections, ribs or the like. They hold an anchor rod introduced into the anchor sleeve in a defined position.

The supporting elements are preferably so arranged and constructed that they support an anchor rod introduced into the anchor sleeve at least approximately coaxially in the anchor sleeve. In this way, a defined position of the anchor rod anchored in the masonry can be achieved. An eccentric and/or out-of-true anchoring of the anchor rod in the anchor sleeve is avoided.

One embodiment of the invention provides resiliently and/or plastically deformable supporting elements. The deformability is achieved by the shape of the supporting elements and by the material, for example, plastics material, of the supporting elements. The deformability of the supporting elements has the advantage that the supporting elements accommodate different diameters of anchor rod.

The supporting elements can be in the form, for example, of studs, projections, circumferential ribs or the like. One embodiment of the invention provides supporting ribs as supporting elements, which extend in the lengthwise direction of the anchor sleeve or alternatively helically. This has the advantage that the anchor sleeve is easy to remove from a mould when the anchor sleeve is manufactured from plastics material by injection moulding or a comparable manufacturing method. Supporting ribs as supporting elements have the added advantage that they are deformable when an anchor rod is inserted in the anchor sleeve.

A development of the invention provides for the supporting ribs to be arranged laterally offset with respect to notional axial planes of the anchor sleeve. The supporting ribs therefore project not radially but inwardly as chords. This construction of the invention has the advantage that the supporting ribs abut not at right angles but in the direction of a secant on the circumference of an anchor rod introduced into the anchor sleeve and can therefore be pressed to one side and deformed more easily by the anchor rod. This allows the anchor sleeve to adapt easily to different diameters and enlarges the potential diameter range of anchor rods that can be introduced into the anchor sleeve. Coaxial support of anchor rods of different diameters in the anchor sleeve is easily possible.

The invention is explained in detail in the following with reference to an exemplary embodiment illustrated in the drawings, in which:

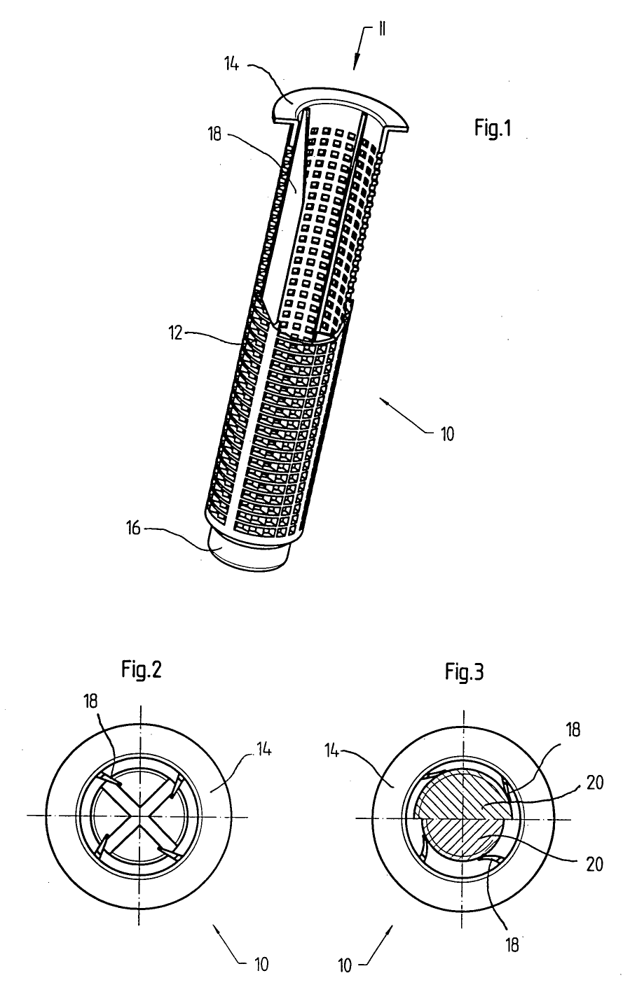

FIG. 1 is a perspective view of an anchor sleeve according to the invention;

FIG. 2 is an end view of the anchor sleeve in accordance with arrow II in FIG. 1; and

FIG. 3 shows the anchor sleeve with an inserted anchor rod in a view corresponding to that of FIG. 2, two different anchor rod diameters being illustrated.

The anchor sleeve 10 for injection fixing illustrated in FIG. 1 is manufactured in one piece from plastics material. The anchor sleeve 10 is in the form of a mesh sleeve, that is, its circumferential wall is of mesh-like construction with a plurality of mesh holes, which form outlet openings 12 for egress of mortar injected into the anchor sleeve 10. The rear end of the anchor sleeve 10 is open for insertion of an anchor rod, not shown in FIG. 1, and the rear end has an outwardly extending positioning collar 14 in the form of an annular washer, which is integral with the anchor sleeve 10. The leading or insertion end 16 of the anchor sleeve 10 is of closed construction. The anchor sleeve 10 is introduced with its leading end at the front into a hole in masonry, not illustrated.

On its inside, the anchor sleeve 10 according to the invention has supporting ribs 18, which form supporting elements for an anchor rod insertable in the anchor sleeve 10. In the exemplary embodiment of the invention being illustrated and described, the anchor sleeve 10 has four supporting ribs 18, which are arranged uniformly distributed over the circumference. The supporting ribs 18 extend in the lengthwise direction of the anchor sleeve 10; they are integral with the anchor sleeve 10, therefore, like this, consist of plastics material and are resiliently and/or plastically deformable. The supporting ribs 18 are arranged not radially in the anchor sleeve 10, that is, not in notional axial planes of the anchor sleeve 10, but, as can be seen in FIG. 2, are offset laterally and circumferentially in relation to notional axial planes of the anchor sleeve 10. All four supporting ribs 18 are here offset in the same circumferential direction and by the same displacement. The supporting ribs 18 are arranged as chords and symmetrically.

The supporting ribs 18 hold an anchor rod 20, for example, a threaded rod, inserted in the anchor sleeve 10 coaxially in the anchor sleeve 10. As the anchor rod 20 is inserted into the anchor sleeve 10, it presses the supporting ribs 18 to one side, which is facilitated by the arrangement of the supporting ribs 18 as chords. By virtue of the arrangement as chords, the supporting ribs 18 abut not at right angles to the circumference of the anchor rod 20, but in a secant direction, which enables the supporting ribs 18 to be pressed more easily to one side. Despite this, coaxial support of the anchor rod 20 in the anchor sleeve 10 is ensured. The supporting ribs 18 enable anchor rods 20 of different diameters to be inserted in the anchor sleeve 10. An anchor rod 20 of large diameter presses the supporting ribs 18 further to one side than an anchor rod 20 of smaller diameter. The coaxial support of the anchor rods 20 of different diameter is illustrated in FIG. 3, in which the upper half of the image illustrates one half of an anchor rod 20 of large diameter and the lower half of the image illustrates one half of an anchor rod 20 of small diameter.

The anchor sleeve 10 is used as follows: to anchor an anchor rod 20, the anchor sleeve 10 is introduced into a hole drilled in masonry, not illustrated, so that it is located with its positioning collar 14 on the masonry. A mortar, especially a synthetic resin mortar, is subsequently injected into the anchor sleeve 10 through the open rear end of the same. The injected mortar passes through the outlet openings 12 out of the anchor sleeve 10 into a gap between the anchor sleeve 10 and the drilled hole, not illustrated. After injection of the mortar, the anchor rod 20 is introduced into the anchor sleeve 10, the anchor rod 20 displacing and compacting the injected mortar. The supporting ribs 18 guide the anchor rod 20 coaxially and ensure a coaxial alignment of the anchor rod 20 in the anchor sleeve 10. Once the mortar has hardened, the anchor rod 20 is firmly anchored in the drilled hole.

1. Anchor sleeve for injection fixing, the anchor sleeve having outlet openings for egress of mortar injected into the anchor sleeve, characterised in that the anchor sleeve (10) has inwardly extending supporting elements (18), which, in the anchor sleeve (10), support an anchor rod (20) introduced into the anchor sleeve (10).

2. Anchor sleeve according to claim 1, characterised in that the supporting elements (18) support an anchor rod (20) introduced into the anchor sleeve (10) at least approximately coaxially in the anchor sleeve (10).

3. Anchor sleeve according to claim 1, characterised in that the supporting elements (18) are deformable.

4. Anchor sleeve according to claim 1, characterised in that the supporting elements (18) are in the form of supporting ribs (18) extending in the lengthwise direction or helically.

5. Anchor sleeve according to claim 4, characterised in that the supporting ribs (18) are arranged circumferentially offset in relation to notional axial planes of the anchor sleeve (10).
